(19) United States
(12) Patent Application Publication
(10) Pub. No.: US 2012/0330478 A1
(43) Pub. Date: Dec. 27, 2012

(54) Energy Saving at a Network Node in an Automation Network

(75) Inventor: Christian MALSCH, Pforzheim-Eutingen (DE)

(73) Assignee: Siemens Aktiengesellschaft, Muenchen (DE)

(21) Appl. No.: 13/529,800

(22) Filed: Jun. 21, 2012

(30) Foreign Application Priority Data
Jun. 22, 2011 (EP) EP11170892.1

(51) Int. Cl. G06F 1/32

(52) U.S. Cl. 700/297

(57) ABSTRACT

A method for saving energy at a network node in an automation network comprising receiving energy saving command data for switching at least one network device to an energy saving state, forwarding the energy saving command data to the network device, evaluating the energy saving command data by the network node, and saving energy at the network node. When the network node receives and/or outputs no data or a reduced volume of data to the network device during the energy saving state, the energy saving is effected by placing at least one portion of the network node into an energy saving state, where the portion is determined by any one of a plurality of network ports, which, because of the energy saving state of the network device, is being used to output and/or receive no data or a reduced volume of data.

### BACKGROUND OF THE INVENTION

1. Field of the Invention

The invention relates to power management and, more particularly to, a method for saving energy at a network node in an automation network.

2. Description of the Related Art

The prior art discloses approaches for reducing the power consumption of network components. What is known as an “Energy Efficient Ethernet” is already standardized under the IEEE 802.3AZ standard. U.S. Pat. No. 6,993,667 B1 describes a receiver having two energy saving modes. US 2007/0041387 A1 discloses control units for communicating power management information via the network cable.

### SUMMARY OF THE INVENTION

It is an object of the invention to provide an improved method for saving energy at a network node, a network node, a automation network and a computer program product.

This and other objects and advantages are achieved in accordance with the invention by a method for saving energy at a network node in an automation network in which network devices are connected to network ports at the network node.

By way of example, an automation network may comprise an industrial automation network. Such industrial automation networks may, for example, be configured, set up and/or provided for the purpose of controlling and/or regulating industrial installations (e.g., production installations or conveyor installations), machines and/or devices. In particular, automation networks or industrial automation networks may have realtime communication protocols (e.g., Profinet, Profibus, RealTime Ethernet) for the communication at least between the components involved in the control and/or regulatory tasks (e.g., between the control units and the installations and/or machines which are to be controlled). The secure transmission of data via storage media is likewise covered.

Possible examples of further protocols which are used in an automation network are: Internet Protocol (IP), Transmission Control Protocol (TCP), Foundation Fieldbus, Common Industrial Protocol (CIP), Interbus, Hart, Ethercat, Ethernet Powerlink, Modbus, Sercos, Safetynet.

In addition, besides a realtime communication protocol, there may also be provision for at least one further communication protocol (which does not need to have realtime capability, for example) in the automation network or industrial automation network, however, e.g., for the purpose of monitoring, setting up, reprogramming and/or reparameterizing one or more control units in the automation network.

By way of example, an automation network may comprise wired communication components and/or wireless communication components. Furthermore, an automation network may comprise at least one automation device.

By way of example, an automation device may be a computer, PC and/or controller with control tasks or control capabilities. In particular, an automation device may be an industrial automation device, for example, which may be configured, set up and/or provided specifically for the purpose of controlling and/or regulating industrial installations, for example. In particular, such automation devices or industrial automation devices may have realtime capability, i.e., may allow control or regulation in realtime. To this end, the automation device or the industrial automation device may comprise a realtime operating system, for example, and/or may, at least inter alia, support a communication protocol with realtime capability for communication (e.g., Profinet, Profibus, RealTime Ethernet).

An automation network comprises a plurality of sensors and actuators. The actuators and sensors are controlled by at least one control device. The actuators, the sensors and the at least one control device interchange data with one another. An automation protocol is used for the data interchange. The at least one control device controls the actuators, the sensors and the data interchange such that an automated production process occurs, in which a product is manufactured, for example.

By way of example, an industrial automation device may be, or comprise, a programmable logic controller, a module or part of a programmable logic controller, a programmable logic controller integrated in a computer or PC and also appropriate field devices, sensors and/or actuators, input and/or output devices or the like for connection to a programmable logic controller.

An automation protocol within the context of the present invention is understood to mean any kind of protocol that is provided, suitable and/or set up for the purpose of communication with automation devices as per the present description. By way of example, such automation protocols may be the ProfiBus protocol (e.g., as per International Electrotechnical Commission (IEC) Standard 61158/EN50170), a ProfiBus DP protocol, a ProfiBus PA protocol, a ProfiNet protocol, a ProfiNet 10 protocol, an AS Interface protocol, an IO Link protocol, a KNX protocol, a MultiPoint Interface (MPI) protocol, a Point-to-Point (PtP) coupling protocol, a protocol based on the specifications of S7 communication (which, by way of example, is provided and set up for the purpose of communication by programmable logic controllers from the Siemens company) or else an Industrial Ethernet protocol or RealTime Ethernet protocol or further specific protocols for communication with automation devices. The automation protocol provided within the context of the present invention may also be arbitrary combinations of the aforementioned protocols.

Initially, the network node receives energy saving command data. The energy saving command data are intended to switch at least one of the network devices to an energy saving state. In the energy saving state, the at least one network device consumes less energy than in an operating state. By way of example, the energy saving state may be a standby state of the network device. The operating state is the state of the network device which is assumed by the network device during the automation process when it needs to produce or process or forward data for the automation process. The energy saving state may also be a state in which the network device consumes no energy. By way of example, the network device is then totally switched off in the energy saving state. It should be understood that it is advantageous if the network device can be switched back to the operating state or to another energy saving state at least by a signal from the network node. This could be accomplished by a “wake on LAN” signal, for example.

The energy saving command data are sent to the network device, for example, by a control unit in the automation network, when there are stoppages in the automation process or there is maintenance or a break. By way of example, network devices can be switched to the energy saving state when workers involved in the production process take a break and the automation process likewise needs to be interrupted.

By way of example, the energy saving command data may be data relating to the energy saving as per what is known as the PROFIenergy profile.

The energy saving command data are forwarded from the network node to the network device. Furthermore, the energy saving command data are evaluated by the network node. In this case, evaluation of the energy saving command data is understood to mean particularly that the network node can read and evaluate the content of the energy saving command data. The network node is thus able to store information about the energy saving command data, for example, after the energy saving command data have been evaluated. By way of example, the network node stores that the network device is switched to the energy saving state by the energy saving command data.

Next, energy saving is effected at the network node. The network node outputs no data or a reduced volume of data to the network device and/or receives a reduced volume of data or no data from the network device when the network device is in the energy saving state. Energy saving at the network node is effected by virtue of at least one portion of the network node being put into an energy saving state. The portion is determined by the at least one network port which, on account of the energy saving state of the at least one network device, is being used to output and/or receive no data or only a reduced volume of data.

Thus, the portion of the network node that is switched to the energy saving state is the one that is required for data transmission to the network device that is in the energy saving state. If, for example, a network node has a plurality of ports and, for one half of the ports, a first processor at the network node is used for forwarding data, and a second processor is used for forwarding data through the second half of the network ports, then the first processor can be switched to the energy saving state when all the network devices that are connected to the first half of the ports have been switched to the energy saving state.

In accordance with the disclosed embodiments of the invention, it thus becomes possible to save energy at the network node without adversely affecting the manner of operation of the automation network. The reason is that the network node has only that portion switched to the energy saving mode that is not required, because this portion would be responsible only for forwarding data to the network devices that are in the energy saving state.

In accordance with the disclosed embodiments of the invention, the network node receives a response signal in response to the energy saving command data from the at least one network device and evaluates the response signal. Here, the energy saving at the network node is effected only when the at least one response signal has been received and evaluated. In other words, the network node awaits the response signal before the portion is put into the energy saving state. The response signal can more or less be understood to be an acknowledgement from the network device that the network device is being switched to the energy saving state.

Such a response signal is advantageous because, for example, the network device cannot confirm being switched to the energy saving state with the response signal if, for example, there is an emergency state or another event that prohibits the network device from being switched to the energy saving state. Here, it is advantageous if the portion of the network node is not switched to the energy saving state, because otherwise the communication with the network device would have been interrupted.

In accordance with other embodiments of the invention, the energy saving command data comprise a period or an end time. The period or the end time defines the period for which the at least one network device is switched to the energy saving state. The portion of the network node is switched to the energy saving state for a shorter time or the same period.

Such a predefined period is advantageous, because both the network device and the portion of the network node that is in the energy saving state can be switched to the operating state in good time before the period elapses, which means that any data to be processed or to be forwarded can be processed or forwarded directly.

This predefined period is advantageous when the network device is intended to be switched to the energy saving state during a break in the production process, for example. Here, the network node establishes the period during evaluation of the energy saving command data and stipulates for itself the shorter or the same period for which it is switched to the energy saving state. Alternatively, the shorter or the same period for which the network node is switched to the energy saving state can also be stipulated by a control unit in the automation network. Here, the period for the energy saving state is transmitted together with the energy saving command data and is read by the network node when the energy saving command data are evaluated. It is advantageous if the network node is switched to the energy saving state for the brevity of the period, because in this case the network node is already able to receive signals and data that are intended to be forwarded to the network device when the network device is not yet in the operating state. The network device can therefore be supplied with the signals or data directly when it is switched to the operating state.

In other embodiments of the invention, after the period has elapsed, the network node automatically switches itself fully or partially to the operating state and produces energy saving termination command data, which are then transmitted to the at least one network device. In other words, the network node is switched on again after the period has elapsed. The energy saving termination command data are produced by the network node and are transmitted to the at least one network device by the network node.

In further embodiments of the invention, the network node can recognize the state of the connected network devices from protocol elements. For example, the state is transmitted by a superordinate controller, such as a programmable logic controller, to the network device via the network node. For example, a port-based filter in the firmware of the network node can ensure that particular messages are recognized and evaluated by the network node. When the message has been evaluated, the network node can decide whether it is switched to the energy saving state, and what part is switched.

Recognition of the states of the connected network devices by the network node is advantageous because the network node therefore knows the states based solely on the energy saving command data, which are already sent anyway, and/or the energy saving termination command data. Thus, no additional signal is needed to provide the network node with information about the states of the network devices.

The network node is notified in advance, by forward planning, of the protocol elements that are to be recognized and/or of times or periods which, when they occur, are intended to prompt at least part of the network node to be switched to the energy saving state.

In other embodiments of the invention, at least two network devices are connected directly or indirectly to at least one of the network ports at the network node. Here, a reduced volume of data or no data are output and/or received via the at least one network port only when all of the at least two network devices are in the energy saving state. In other words, at least one portion of the network node is also switched to the energy saving state in this case when all of the at least two network devices are in the energy saving state. This prevents the communication via the network node from being interrupted for one of the network devices when the portion of the network node is switched to the energy saving state.

In further embodiments of the invention, the network node has an address table that stores addresses for the network devices which are connected to network node. The address table also comprises, for each of the addresses, a network port that is associated with the addresses at the network node. Therefore, the network node is able to associate with an address the respective network port to which the network device with the address is connected.

In additional embodiments of the invention, energy saving termination command data are received via a network port at the network node. The energy saving termination command data are intended, when received by the at least one network device, to switch the at least one network device to an operating state with increased energy intake in comparison with the energy saving state. It should be noted that the energy saving termination command data can also switch the network device from the energy saving state to another energy saving state. In the other energy saving state, the network device consumes more energy than in the first energy saving state, for example. By way of example, a network device could be switched from a switched-off state to a standby state. Alternatively, the network device could also be switched from the switched-off state to the operating state which it normally assumes for the execution of the automation process, or from the standby state to the operating state which it normally assumes when the automation process is executed.

In certain embodiments, the energy saving termination command data may be data based on the PROFIenergy profile.

The energy saving termination command data are evaluated via the network node. The network node which has been switched to the energy saving state at least in part is then switched on again. In other words, that portion of the network node which was in the energy saving state on account of the energy saving state of the network device is switched on again. The energy saving termination command data are then forwarded to the at least one network device.

In other embodiments of the invention, the network node has a buffer store. The buffer store is used to store data that are intended to be forwarded to the at least one network device so long as the at least one network device is in the energy saving state. Such embodiments of the invention may be advantageous because data that are intended to be forwarded to the network device by the network node are buffer-stored. This means that the data are not lost even though the network device is still in the energy saving state.

In additional embodiments, the network node stores the energy states of the connected network devices in a state memory. The energy state of one of the network devices is the operating state or the energy saving state of the respective network device. Using these stored energy states, the network node is advantageously able to determine whether it needs to switch itself to the energy saving state, and what portion needs to be switched.

In other embodiments, the energy state of the at least one network device is requested by a further network device using energy state request command data. Here, the further network device may be a superordinate controller in the automation network, for example, which requests the energy states of the network devices on an irregular or regular basis. The energy state request command data are transmitted via the network node. In this case, the network node responds to the request instead of the network device. This is accomplished by virtue of the network node, upon receiving the energy state request command data, reading the state of the network device from the state memory and outputting a response signal to the further network device. The response signal comprises the energy state of the at least one network device. In other words, the network node thus responds to the state request from the further network device.

This is advantageous because it means that the network device, which is in the energy state, for example, does not need to receive and send any data. If a network device were to need to receive and/or send data in the energy saving state, this would mean that the network device no longer saves as much energy as normal in the energy saving state. This could even extend to the network device, upon receiving the state request, being switched back to the operating state and no more energy at all being saved. This is avoided by virtue of the state request being responded to by the network node.

In additional embodiments of the invention, the automation network comprises a further network node. The further network node is connected to the network node via at least one of the network ports. Furthermore, further network devices are connected to the further network node. No data or a reduced volume of data for the network devices is output to the further network node via the network port only when all the further network devices connected to the further network node are in the energy saving state. In other words, the network node takes account of the network topology. This can either be stored at the network node in the course of the forward planning or else the network node comprises an address database that is used to store which port is used to forward data to which network address. Hence, the network node knows when there are a plurality of network devices connected to one of the network ports. The network node only changes at least part of itself to the energy saving state when all the network devices that are connected to the network port have been switched to the energy saving state. If a response signal is expected as a trigger for switching the network node to the energy saving state, the network node switches part of itself to the energy saving state only when the response signal has been received from all the network devices connected to the network node.

In other embodiments, the connection between the network node and the at least one network device is a safety-relevant connection in the automation network. For example, there may be a safety-relevant connection when safety considerations mean that the connection is required as a redundant data link for another connection. This may be prescribed or desirable for safety-relevant applications, for example. If all the network devices on the network port are now in the energy state, the energy saving at the network node is initiated. In other words, the network node is switched to the energy saving state. However, the safety-relevant connection is maintained nevertheless. The network node is thus switched to the energy saving state only insofar as no more data are output to the network devices. However, it is nevertheless still possible for data to be transmitted via the safety-relevant connection in the event of this connection being needed for a safety-critical application.

It is also an object of the invention to provide a network node for an automation network. The network node comprises a receiver device for receiving energy saving command data. The energy saving command data are intended to switch at least one of the network devices to an energy state. This at least one network device consumes less energy in the energy state than in its operating state. Furthermore, the network node comprises a forwarding device for forwarding the energy saving command data to the at least one network device and an evaluation device for evaluating the energy saving command data. In addition, the network node comprises an energy saving device for saving energy at the network node. When a network device is in the energy state, no data or a reduced volume of data is output to the network device by the network node. The energy saving at the network node is now effected by virtue of at least one portion of the network node likewise being switched to an energy saving state. In this case, the portion is determined by the at least one network port, which, on account of the energy state of the at least one network device, is being used to output and/or receive no data or just a reduced volume of data.

In accordance with the embodiments of the invention, the network node is configured to perform the method in accordance with the embodiments of the invention.

It is a further object of the invention to provide an automation network having at least one network node in accordance with the disclosed embodiments of the invention.

In accordance with the embodiments of the invention, the automation network comprises a plurality of network nodes in accordance with the disclosed embodiments of the invention. Here, a first network node is connected to a second network node by at least one of the network ports at the first network node. In this case, the first network node is configured to output and/or receive no or a reduced volume of data via the network port only when all the network devices connected to the second network node and/or the second network node itself are/is in the energy state.

It is also a further object of the invention to provide a computer program product including instructions that prompt a network node to perform the method in accordance with the disclosed embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiments of the invention are explained in more detail below with reference to the figures, in which:

FIG. 1 shows a schematic block diagram of a network node in accordance with the invention; and

FIG. 2 shows a flowchart of a method in accordance with embodiments of the invention.

### DETAILED DESCRIPTION OF THE PREFERRED EMBODIMENTS

Elements in the subsequent figures are denoted by the same reference symbols if the function of the elements is identical.

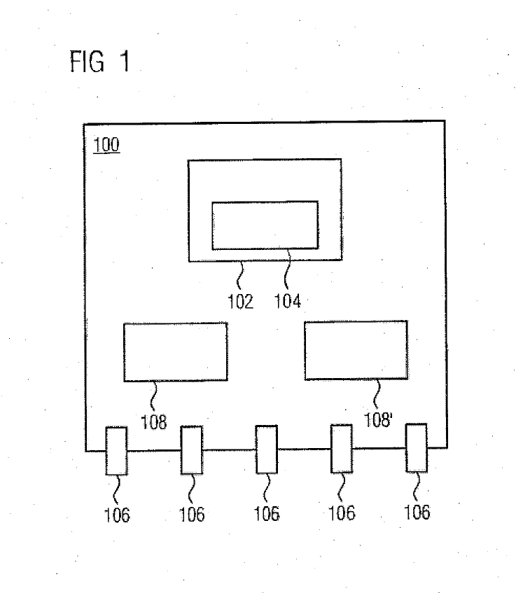

FIG. 1 shows a block diagram of a network node 100. The network node 100 has a data memory 102 that stores program instructions 104. Furthermore, the network node 100 comprises two processors 108 and 108′. The processors 108 and 108′ are configured to execute the program instructions 104. In addition, the network node 100 comprises network ports 106, to which network devices in an automation network (not shown) can be connected. Furthermore, the network node 100 may be connected directly or indirectly to a superordinate controller by one of the network ports 106, where the superordinate controller is able to alter the program instructions 104 and therefore to influence the behavior of the network node 100.

When the program instructions 104 are executed by a processor 108 or 108′ or by both processors 108 and 108′, the network node 100 is prompted to perform the method in accordance with the disclosed embodiments of the invention. The network node 100 receives data that are intended to be forwarded to the network devices on the network ports 106. These data include energy saving command data for the network devices. For example, energy saving command data can be sent from a superordinate unit, such as a programmable logic controller, to a network device via the network node 100. The energy saving command data are forwarded by the network node 100 after reception and are also evaluated. The evaluation is effected by at least one of the processors 108 and 108′. It should be noted that the network node 100 may also comprise just one processor.

If the energy saving command data now switch a network device that is connected indirectly or directly to the network node 100 to an energy state, the network node 100 knows this by virtue of the evaluation of the energy saving command data. If all the network devices that are connected to a particular one of the network ports 106 are in the energy state, at least part of the network node 100 can be switched to an energy saving state.

By way of example, the energy state of the network devices may be a switched-off state or a sleep state or a standby state. It is also possible for there to be different levels of energy savings in the network devices.

The portion of the network node 100 that is disconnected is that which is required for forwarding the data to the network devices which have been switched to the energy state.

If, for example, the processor 108 is configured to forward the data via the first two of the five network ports 106, this processor can be switched to an energy saving state when all the network devices on the first two network ports 106 have been switched to the energy state. This does not adversely affect the operation of the processor 108′, which is configured to forward data via the remaining three network ports 106 at the network node 100. It should be noted that the network node 100 may also have more or fewer than five network ports 106. Furthermore, the processor 100 may also comprise just one processor 108, the power of which is reduced, for example, when network devices are switched to the energy state.

It is also possible for part of the network node 100 to be switched to the energy saving state only when a response signal from the network devices that are intended to be switched to the energy state has been received. This prevents at least part of the network node from being switched to the energy state even though the network devices which should be switched to the energy state have not been switched to the energy state because the reception of the energy saving command data has been ignored. This may be the case, for example, when a network device cannot be disconnected because disconnection could result in safety-critical events. For this reason, it is advantageous if the network node 100 receives a response signal from the network devices. In this context, the response signal is an indication that the network devices have been switched to the energy state. Here, at least part of the network node 100 can be switched to the energy saving state without influencing safety or risking the loss of data.

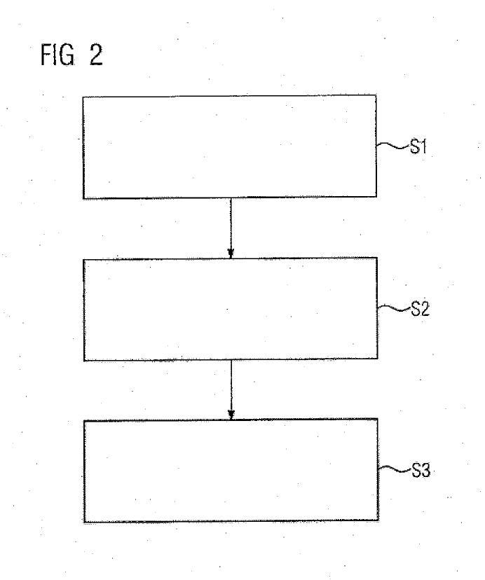

FIG. 2 is a flowchart of a method in accordance with the embodiments of the invention. In step S1, energy saving command data are received by the network node. The energy saving command data are intended to switch at least one network device that is connected to the network node to an energy state. In the energy state, this network device consumes less energy than in an operating state. It should be noted that there may also be more than one energy state. In step S2, the energy saving command data are forwarded to the at least one network device and are evaluated. If the network node has a memory, the energy saving command data can also be stored and can be evaluated only after forwarding. This may be advantageous, for example, when direct evaluation of the energy saving command data is not possible because the processor at the network node is busy with other processes.

If it is now detected, by virtue of the evaluation of the energy saving command data, that all the network devices on a port at the network node have been switched to the energy state, the network node is switched to an energy saving state in step S3. This is achieved by virtue of at least one portion of the network node being put into an energy saving state. In this case, the portion is determined by the at least one network port on which the network devices are in the energy state. If, for example, all the network ports at the network node have only devices that are exclusively in an energy state connected to them, the network node can also be switched completely to an energy saving state.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for saving energy at a network node in an automation network, the method comprising:
receiving energy saving command data for switching at least one network device of network devices connected to network ports at the network node to an energy saving state in which the at least one network device consumes less energy than in an operating state;
forwarding the energy saving command data to the at least one network device;
evaluating the energy saving command data by the network node; and
switching at least a portion of the network node to an energy saving state to save energy at the network node, the network node at least one of receiving and outputting one of no data and a reduced volume of data to the at least one network device when the at least one network node is in the energy saving state;
wherein the at least one portion of the network node to be switched to the energy saving sate is determined based on network ports associated with the at least one network device in the energy saving state.

2. The method as claimed in claim 1, further comprising:
receiving and evaluating, at the network node, a response signal in response to the energy saving command data from the at least one network device;
wherein the energy saving at the network node is effected only after receipt and evaluation of the at least one response signal.

3. The method as claimed in claim 1, wherein the energy saving command data comprise one of a time period and an end time, which defines a period for which the at least one network device is switched to the energy saving state, and wherein the portion of the network node is switched to the energy saving state for one of a shorter time period or a same time period.

4. The method as claimed in claim 3, wherein, after the time period has elapsed, the network node automatically switches itself at least partially to the operating state, and produces energy saving termination command data which is transmitted to the at least one network device.

5. The method as claimed in claim 1, wherein at least one network port of the network ports includes at least two network devices connected to the at least one network port one of directly and indirectly, and wherein no data or a reduced volume of data is at least one of output and received through the at least one network port only when all of the at least two network devices are in the energy saving state.

6. The method as claimed in claims, further comprising:
receiving energy saving termination command data through a network port of the network ports, the energy saving termination command data, when received by the at least one network device, switching said at least one network device to the operating state with increased energy intake in comparison with the energy saving state;
evaluating the energy saving termination command data by the network node; and
re-switching on the network node which has at least partially been switched to the energy saving state;
forwarding the energy saving termination command data to the at least one network device.

7. The method as claimed in claim 1, wherein the network node includes a buffer store configured to store data which are intended to be forwarded to the at least one network device when the at least one network device is in the energy saving state.

8. The method as claimed in claim 1, wherein the network node stores energy states of the network devices connected to network ports at the network node in a state memory, and wherein the energy state of each respective network device of network devices connected to network ports at the network node is one of the operating state and the energy saving state of the respective network device.

9. The method as claimed in claim 8, further comprising:
requesting an energy state of the at least one network device by a further network device by using energy state request command data which are transmitted through the network node; and
reading, by the network node, a state of the network device from the state memory and outputting a response signal to the further network device upon receiving the energy state request command data;
wherein the response signal comprises the energy state of the at least one network device.

10. The method as claimed in claim 1, wherein the automation network comprises a further network node connected to the network node by at least one of the network ports;
wherein further network devices are connected to the further network node, and wherein one of no data and a reduced volume of data for the network devices is output to the further network node through the network port only when all further network devices connected to the further network node are in the energy saving state.

11. The method as claimed in claim 1, wherein a connection between the network node and the at least one network device comprises a safety-relevant connection in the automation network; and wherein the safety-relevant connection is maintained irrespective of the energy saving at the network node.

12. A network node for an automation network, comprising:
network ports configured to receive energy saving command data for switching at least one network device to an energy saving state in which the at least one network device consumes less energy in than in an operating state; and
a process and memory configured to forward the energy saving command data to the at least one network device, evaluate the energy saving command data, and save energy at the network node by switching at least a portion of the network node to an energy savings state;
wherein the network node at least one of receives and outputs one of no data and a reduced volume of data to the at least one network device when in the energy saving state; and
the at least a portion of the network node to be switched to the energy saving state being determined based on network ports associated with the at least one network device in the energy saving state.

13. An automation network including at least one network node as claimed in claim 12.

14. An automation network comprising at least one network node as claimed in claim 13.

15. A process in which a computer executes instructions set forth in a computer program executing on a processor which, when used on the computer cause the processor to save energy at a network node in an automation network, the computer program comprising:
program code for receiving energy saving command data for switching at least one network device of network devices connected to network ports at the network node to an energy saving state in which the at least one network device consumes less energy than in an operating state;
program code for forwarding the energy saving command data to the at least one network device;
program code for evaluating the energy saving command data by the network node; and
program code for switching at least a portion of the network node to an energy saving state for saving energy at the network node, the network node at least one of receiving and outputting one of no data and a reduced volume of data to the at least one network device when the at least one network node is in the energy saving state;
wherein the at least one portion of the network node to be switched to the energy saving sate is determined based on the ones of the network ports associated with the at least one network device in the energy saving state.
